(19) United States
(12) Patent Application Publication
(10) Pub. No.: US 2022/0142752 A1
(43) Pub. Date: May 12, 2022

(54) METHOD FOR PRODUCING A COMPONENT USING A THREE-DIMENSIONAL PRINTING METHOD

(71) Applicant: DEKEMA DENTAL-KERAMIKÖFEN GMBH, Freilassing (DE)

(72) Inventors: Michael MILLER, München (DE); Alexander WENDT, Freilassing (DE); Maurius WEIST, Niederkrüchten (DE); Marco FÜRLE, Freilassing (DE); Stephan MILLER, Traunstein (DE)

(21) Appl. No.: 17/426,661

(22) PCT Filed: Jan. 30, 2020
(86) PCT No.: PCT/EP2020/052210

§ 371 Date: Jan. 11, 2022

(30) Foreign Application Priority Data
Jan. 30, 2019 (DE) 10 2019 102 359.9

(51) Int. Cl. A61C 13/00; B33Y 10/00; B33Y 40/20; B33Y 30/00; B29C 64/35; B29C 64/124; B33Y 80/00

(52) U.S. Cl. CPC A61C 13/0019; B33Y 10/00; B33Y 40/20; B33Y 30/00; B29L 2031/7532; B29C 64/124; B33Y 80/00; A61C 13/0013; B29C 64/35

(57) ABSTRACT

The present invention relates to a method of manufacturing a component, in particular a component that is used in the manufacture of dental components or a dental component, by means of a three-dimensional printing process, said method comprising the steps:
providing a base element: and
printing the component in a liquid bath on the base element such that the component has a hollow space after a completion of the printing,
   wherein at least one channel is provided that establishes a fluid connection between the hollow space and the environment at least after the completion of the printing. The present invention further relates to a system comprising a printing apparatus for printing a component in a liquid bath in accordance with the method described above.

The present invention relates to a method of manufacturing a component by means of a three-dimensional printing process.

Due to increasingly more precise 3D printers, such printing processes are meeting with broad approval in sectors in which components have to be individually shaped. There is in particular a need for individually produced components in the dental sector since a dental prosthesis or a partial dental prosthesis has to be adapted to the respective requirements of each patient.

The manufacture of a dental prosthesis or partial dental prosthesis is comparatively complex and/or expensive since high quality standards have to be maintained and a precise production of such components is crucial. At the same time, it should be as efficient and cost-effective as possible. A possible manufacturing process of dental prostheses or partial dental prostheses will be described by way of example in the following.

In a first step, digital data of the dentition of the patient are generated. These data can be acquired directly by an intraoral scanning process. However, it is also possible to first create a negative impression of the dentition and to use it to manufacture a positive model of the dentition. This positive model can then be scanned. The digital data of the dentition form the basis for the digital planning of the dental prosthesis or partial dental prosthesis to be manufactured. The data obtained through the digital planning are then used to manufacture models that are in turn used to provide negative molds that serve as “lost molds.” After a burning out of the models, the negative molds are filled with a raw material from which the dental prosthesis or partial dental prosthesis should be manufactured. The raw material is hardened in the negative molds by a firing/pressing process. After the removal of the negative molds, the generally finished dental prosthesis or partial dental prosthesis components are finally available that can subsequently still be reworked if required.

It has been recognized that the development of 3D printers has in the meantime advanced to the point that they should in principle be suitable for creating the models of the components to be produced. However, in processes in which a liquid base material is gradually locally solidified to create the model, such as in stereolithography or in the CLIP process (continuous liquid interface production), there is generally the problem that residues of unhardened base material adhere to the model. These residues can lead to a deformation of the model and/or other defects in further process steps, for example because the model hardens unevenly and/or the residues evaporate, whereby an overpressure locally arises in the model. This is particularly problematic with complex model geometries having undercuts and/or hollow spaces since considerable quantities of the liquid base material can collect there.

It is therefore an object of the present invention to provide a remedy in this case and to provide an improved method of manufacturing components, in particular components in the sector of dental technology.

In accordance with the invention, a base element is first provided. The component is then printed in a liquid bath on the base element such that the component has a hollow space after a completion of the printing. The term “hollow space” is to be broadly interpreted in this respect. A hollow space can, for example, be a closed cavity or can be partly open. To be able to remove residues of the liquid of the bath collecting in the hollow space and/or excess printing material that is the material from which the component is printed at least one channel is provided that establishes a fluid connection between the hollow space and the environment at least after the completion of the printing. This makes it possible not only to flush unwanted material out of the hollow space, but also to bring about a pressure equalization between the hollow space and the environment in order to avoid unwanted deformations of the component during or after its manufacture.

The properties of the printing material and/or of the liquid which forms the bath and/or the design and dimensioning of the component and/or the properties of a fluid for flushing or drying the hollow space (for example, a gas or a liquid) can be taken into account in the design and dimensioning of the at least one channel in order to optimize the manufacturing process. One important parameter, among others, is in this respect the viscosity of the liquids or gases used in the manufacturing process. Decisive parameters that define the design and dimensioning of the at least one channel are, for example, its length, its diameter, its shape in its longitudinal extent, its cross-sectional shape, and/or its wall thickness. The introduction of the fluid into the hollow space through the channel can take place by means of excess pressure. However, it is also conceivable to suck fluids out of the hollow space through the channel.

Further embodiments of the invention are set forth in the description, in the drawings, and in the enclosed Figures.

In accordance with an embodiment of the method, the channel is at least sectionally bounded by the base element. I.e. the base element at least sectionally forms a wall of the channel.

The channel can at least sectionally be integrated into the base element. Said channel is in particular at least sectionally formed in one piece with the base element. For example, the channel is (partly) integrated into the base element. It can, for example, comprise a bore in the base element. It is also possible to provide a plurality of bores in the base element that are arranged such that at least one connection between the hollow space and the environment is also established “automatically”, so to speak, on the manufacture of the most varied components.

It is also conceivable to (partly) produce the channel separately and to fasten it to the base element such that it is at least sectionally integrated into the component in the printing process. Figuratively speaking, one can also imagine an at least sectional “reprinting” of the channel. The channel can consist of the same or a different material as or than the component and/or the base element and/or can comprise more than one material.

In accordance with a further embodiment, the channel is at least partly produced, preferably completely produced on the printing of the component, in particular by the printing process. This simplifies the manufacture of the component since the channel can then at least partly already be “co-planned” on the creation of a digital model of the component and can be optimized in accordance with the printing materials used and/or the properties of the liquid bath and/or of the flushing/drying fluid.

The printing process can be designed such that the hollow space is at least sectionally bounded by the base element after the completion of the printing. For example, the base element is a plate on which a cylindrical component is printed that is closed at the side remote from the base element.

The channel can have at least one wound section, one curved section, and/or one section extending obliquely to a longitudinal axis of the channel. In this design, a comparatively low viscosity fluid can be introduced into or removed from the hollow space in an unproblematic manner while the penetration of a comparatively high viscosity fluid is reliably prevented at the same time. The design of the wound section, the curved section, and/or the section extending obliquely to a longitudinal axis of the channel (a combination of two or more such sections is likewise possible) can be adapted to the properties of the fluids used in the manufacturing process of the component and/or to the properties of materials with which the component will later come into contact. Comparatively low viscosity fluids are, for example, the liquid plastic, from which the component is manufactured, and/or a flushing fluid. An example of a high viscosity material would be an embedding medium that is used to embed the component in order to manufacture a lost mold.

The at least one channel can generally have a constant cross-section. To optimize its permeability properties, a cross-section of the channel can vary locally.

In accordance with a further embodiment of the method, an end of the channel remote from the hollow space has an interface for connecting the channel to a separate fluid system, in particular with the interface being produced by the printing process. The interface, for example, serves to connect a hose, a nozzle or the like to the channel in order to introduce a flushing fluid into the hollow space and/or to exert an excess pressure or an underpressure on the hollow space. To simplify the connection of the channel to the flow system, the interface can have mechanical coupling elements, for example, suitably shaped grooves, projections or the like.

At least one support structure for increasing the stability of the component and/or at least one guidance structure for selectively guiding fluid can be provided in the interior of the hollow space. The support structure and/or the guidance structure is/are in particular produced on the and/or by the printing of the component. The guidance structure can in particular be designed such that it assists the flushing and/or the drying of the component by guiding the fluids used in the process to the critical regions and/or away from them and/or toward the end of the channel at the hollow space side. Provision can be made that the support structure and/or the guidance structure is/are in connection with the channel.

At least two channels can be provided that are in fluid communication with the hollow space, with the channels being distributed in a peripheral direction of the component, preferably being arranged disposed opposite one another relative to the component, and/or with the channels being arranged in one plane or in different planes, viewed in a printing direction of the component. The number and/or the spatial arrangement of the channels is/are in particular selected such that the flushing and/or the drying of the hollow space is/are optimized. For example, at least one inlet channel and one outlet channel can be provided for the flushing fluid to enable a flushing through of the hollow space.

The method in accordance with the invention is in particular used in conjunction with a stereolithography process, a CLIP process (continuous liquid interface production), and/or a hybrid process.

In accordance with an embodiment of the method, the liquid of the liquid bath present in the hollow space is removed through the channel after the printing. A flushing fluid, e.g. a flushing liquid and/or a flushing gas, can be introduced into the hollow space through the channel after the printing. The flushing fluid can also have a cleaning effect. The use of a gas or gas mixture (e.g. air) saturated with alcohol vapor has proved to be advantageous. The flushing of the component or of the hollow space can be repeated as often as desired. In this respect, provision can also be made to remove the flushing fluid from the hollow space by suction.

After the flushing of the component, it can be dried. In accordance with an advantageous embodiment, the drying takes place by introducing a “dry” gas or gas mixture into the hollow space. A gas or gas mixture heated above environmental temperature can be used in this respect. It is understood that the flushing and drying can merge into one another or can take place at the same time.

After a removal of the liquid from the hollow space and/or after the flushing and/or drying of the hollow space or of the component, the component can be hardened, in particular by means of radiation (e.g. UV radiation) and/or heat input. The drying and hardening can also merge into one another or take place simultaneously.

The channel and/or the base element can be separated from the component after the printing, after the flushing, after the drying, or after the hardening of the component. When this takes place can depend on whether the channel and/or the base element is/are still required for a subsequent method step or not. To facilitate the separation, desired separation points, for example deliberately provided weakness zones, can be provided at the component, at the base element, and/or at the channel. These desired separation points are in particular produced in the printing process.

The present invention further relates to a system comprising a printing apparatus for printing a component in a liquid bath in accordance with a method in accordance with at least one of the preceding claims.

In accordance with the invention, a system comprising a flushing apparatus for flushing a component is also proposed that was manufactured in accordance with a method in accordance with any one of the embodiments described above. The flushing apparatus can have a flushing device which can be coupled to the channel of the component and by which a flushing liquid and/or a flushing gas can be introduced into the hollow space, in particular with the flushing liquid and/or the flushing gas being able to be introduced pressurized into the hollow space and/or being able to be sucked from it. The flushing can also comprise drying the component.

In accordance with an embodiment of the system, the flushing apparatus comprises a flushing chamber in which the component can be arranged, with the flushing chamber having at least one flushing element, in particular a nozzle, for applying a flushing liquid and/or a flushing gas to the component. In this way, the component can also be flushed, cleaned, and/or dried from the outside.

It is generally possible to provide a separate drying apparatus for drying the component. However, a more compact design of the system results if the drying apparatus is integrated into the flushing apparatus.

The same applies to an optionally provided hardening apparatus for hardening the component. The hardening apparatus can be integrated into the flushing apparatus or the drying apparatus.

A fixing apparatus is in particular provided for a positionally accurate fixing of the base element in the printing apparatus, in the flushing apparatus, in the drying apparatus, and/or in the hardening apparatus. In accordance with an advantageous embodiment, the fixing apparatus of the individual aforementioned apparatus are identical or compatible to the extent that the base element can be fixed without problem in all the apparatus in a known position in each case. For this purpose, suitable mechanical codings and/or markings can be provided at the base element, on the one hand, and at the aforementioned apparatus, on the other hand.

The present invention will be explained in the following purely by way of example with reference to advantageous embodiments and to the enclosed drawings. There are shown:

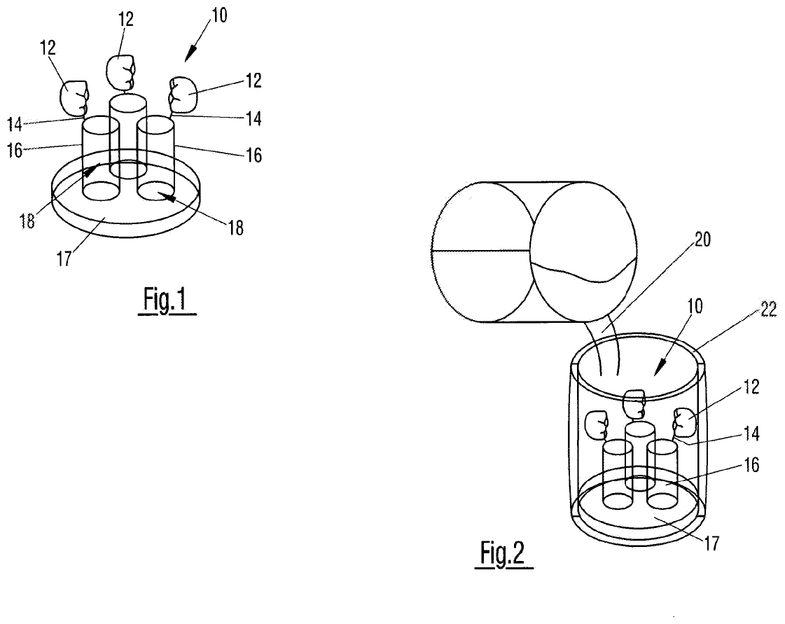

FIG. 1 a model manufactured using digital data by means of 3D printing;

FIG. 2 the embedding of the model;

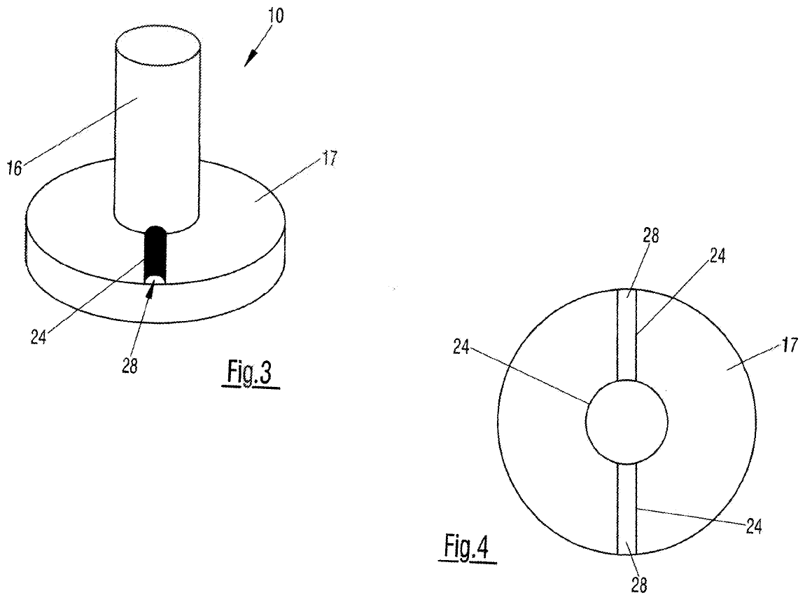

FIGS. 3 and 4 a first embodiment of the present invention;

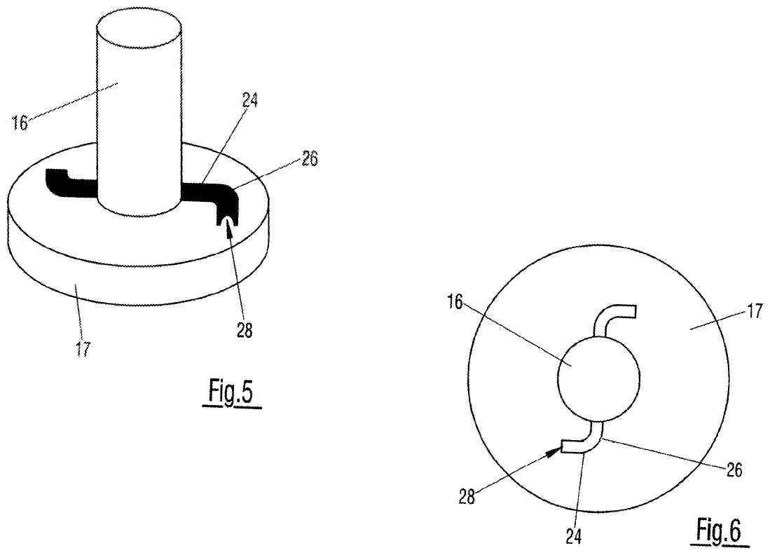

FIGS. 5 and 6 a second embodiment of the present invention;

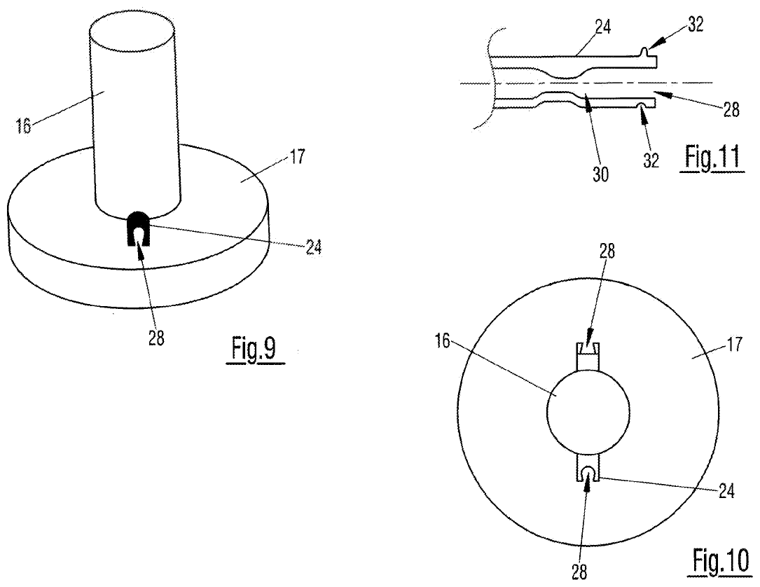

FIGS. 7 and 10 a third embodiment of the present invention;

FIGS. 9 and 10 a fourth embodiment of the present invention;

FIG. 11 a fifth embodiment of the present invention;

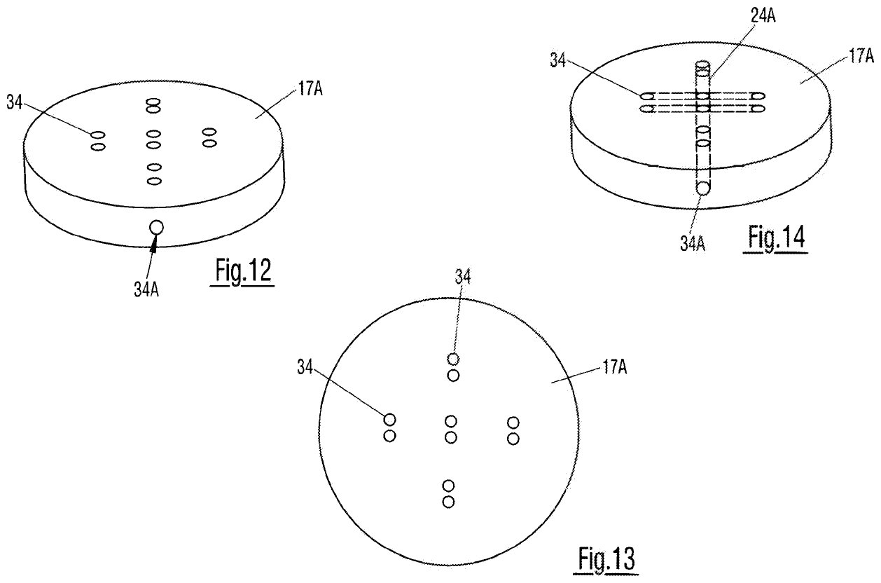

FIGS. 12 to 14 a sixth embodiment of the present invention;

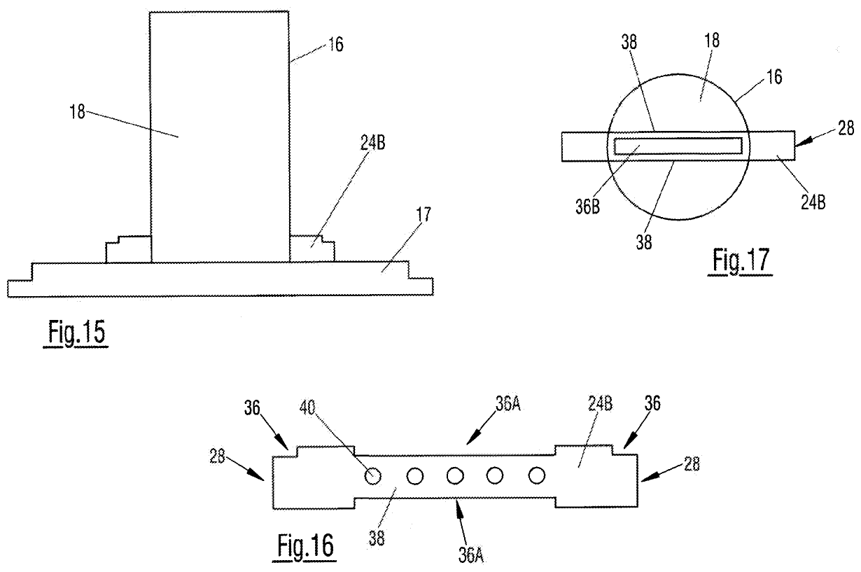

FIGS. 15 to 17 a seventh embodiment of the present invention; and

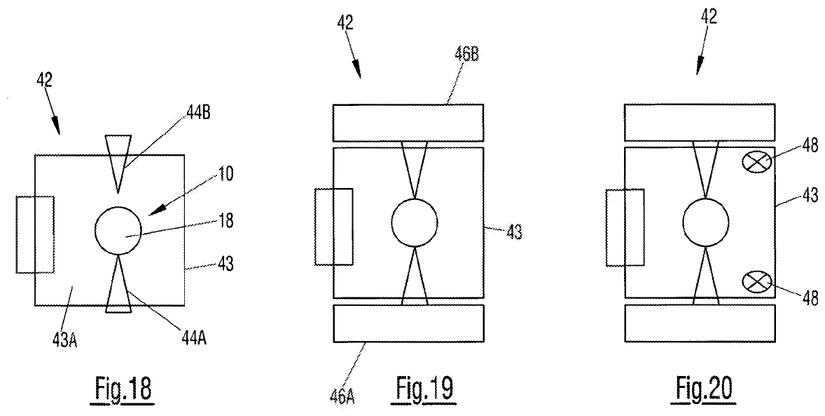

FIGS. 18 to 20 a system in accordance with an embodiment of the present invention.

FIG. 1 shows, by way of example, a model 10 that is used for the manufacture of a dental prosthesis or partial dental prosthesis. In the present example, it comprises three dental prosthesis components 12 that are arranged on hollow cylinders 16 by means of webs 14 in each case. The model 10 is printed on a base element 17 by means of 3D printing. In the present case, the base element 17 is a plate. However, any desired other geometries of the base element 17 are conceivable.

A suitable printing process is, for example, stereolithography in which a light-curing liquid plastic is hardened in thin layers by a laser. This process takes place in a bath of the plastic. After the hardening of each layer through the irradiation by the laser, the component to be manufactured is lowered by a layer thickness. The liquid plastic disposed above the component is then uniformly distributed by a wiper. Subsequently, the liquid plastic is irradiated by laser light again in order to form the next component layer. The three-dimensional model 10 is gradually created in this manner.

In the CLIP process (continuous liquid interface production), the component is manufactured continuously. A bath of a light-curing plastic is also present here. However, in this process, a laser beam is directed through a base of the container of the plastic bath, which is transparent for the wavelength used, and is focused precisely where the plastic should harden. The object to be printed is slowly pulled out of the plastic bath by a platform such that the liquid plastic can always flow into the thin intermediate space between the object and the base. The base is designed such that the hardening plastic does not adhere to it.

Variants and refinements of these processes are generally known. In addition to the aforementioned processes, other 3D printing processes (also hybrid processes) can also be used.

However, there is the problem with complex model geometries that liquid plastic can collect in undercuts and/or hollow spaces of the model. As has been initially described, this can lead to a deformation of and/or other damage to the model. In the example of FIG. 1, liquid collects in the interior of the hollow cylinders 16 and cannot escape after the completion of the printing process. This can, for example, result in a pressure difference forming between a respective inner space or hollow space 18 of the cylinders 16 and the outer space (e.g. due to an outgassing of the liquid plastic), said pressure difference having a negative effect on the shape of said outer space.

FIG. 2 shows the step of embedding the model 10 by means of an embedding medium 20. A housing cylinder 22 was placed onto the plate 17 for this purpose.

After the embedding of the model 10 and the hardening of the embedding medium 20, the printed model 10 is burned out such that a hollow negative mold of the model 10 is formed in the embedding medium 20. The negative mold is now (partly) filled with a raw material for the dental prosthesis components 12 to be manufactured and is subsequently fired. During the firing, an exertion of pressure on the raw material can optionally be provided that is produced by pressure stamps. They are movably arranged in the cylindrical hollow spaces that are created by the hollow cylinders 16 of the model 10.

The unwanted liquid accumulations described above and associated problems have led to the prejudice that 3D printing processes can be problematic at least in the dental sector in which particular precision is important. It was already possible to provide a remedy in this case through the present invention.

FIG. 3 shows a hollow cylinder 16 printed on the base element 17 (the components 12 and webs 14 have been omitted for reasons of simplicity). To be able to remove liquid from the interior of the cylinder 16, a channel 24 is provided whose interior is in contact with the hollow space 18 of the cylinder 16. Liquid can thereby drain from the cylinder 16. The channel 24 can also be used to flush the hollow space 18, for example, with a liquid and/or with a gas. The channel 24 also enables a pressure equalization and/or an active or a passive drying of the hollow space 1. An application of fluid to the hollow space 18 can take place at a (small) excess pressure if necessary. An application of an underpressure (fluid suction) is also conceivable.

FIG. 4 shows a plan view so that it can be recognized that two channels 24 are provided that viewed relative to the cylinder 16 are disposed opposite one another. One of the two channels 24 can serve as an inlet channel for a flushing fluid or drying fluid while the other channel 24 serves as an outlet channel. The hollow space 18 can thus be efficiently flushed through. It is understood that any desired number of channels 24 can be provided.

In the embodiment shown by way of example, the channels 24 have a semicircular cross-section. In general, any desired cross-sectional shapes, which can also vary in the longitudinal direction of the channels 24 if required, are conceivable.

The channels 24 can be formed by the printing process and are in particular produced from the same material as the cylinder 16. However, it is also possible that the channels 24 are formed in one piece with the base element 17 and/or can be (partly) integrated into it. The channels 24 are then figuratively speaking “printed around” by the cylinder 16.

In accordance with a variant of the method, separate channel components in the present example this would then be two channel-like half-shells are provided that are fastened to the base element 17 prior to the printing process. They can be composed of the same material from which the model 10 is printed. However, the selection of other materials is also possible. The same applies to mixed forms of the variants described above.

The ends of the channels 24 remote from the cylinder 16 each have an opening 28. The channels 24 extend up to the margin of the base element 17 such that the housing cylinder 22 closes the openings 28 on an embedding of the model 10 and consequently no embedding medium 20 can enter the cylinder 16.

FIG. 5 and FIG. 6 show a further variant of the invention. Here, the channels 24 are not designed in a straight line throughout, but each have a bend 26 of approximately 90° in their course. Moreover, they do not extend up to the margin of the base element 17, Thus, the openings 28 of the channels 24 are indeed exposed on the embedding. However, the bends 26 prevent the comparatively high viscosity embedding medium 20 from entering the hollow space 18. However, the bends 26 do not oppose an outflow of a low viscosity fluid from the hollow space 18.

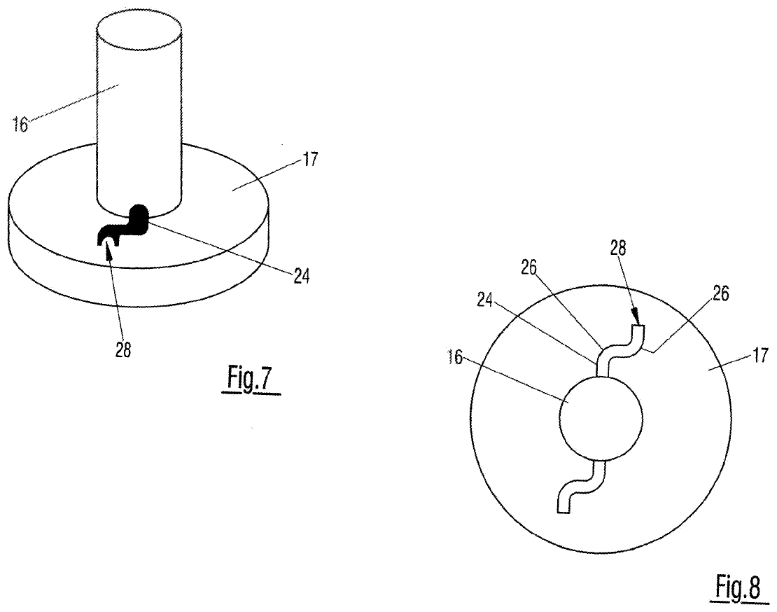

The bends 26 can have any desired angles and/or radii of curvature. Any desired number of bends 26 can also be provided as shown by way of example with reference to the embodiment shown in FIGS. 7 and 8. The geometric design of the channels 24 and/or their number can be adapted to the properties of the fluids used in the manufacturing process such that the desired fluids can pass through the channels 24 while other fluids are reliably prevented from doing so. Parameters that define the geometric design of the channels 24 include, among others, their length, their course, their cross-sectional shape (that can also vary in the course of the channels), and their spatial arrangement.

FIGS. 9 and 10 show comparatively short channels 24 having a cross-section that deviates from a semicircular shape. Their cross-sectional shape is approximately horseshoe-shaped here.

To create a viscosity-dependent permeability of the channels 24, the channels 24 can additionally or alternatively also have cross-sectional variations if required. A local constriction 30 is shown by way of example in FIG. 11 and is caused by an indentation of the channel wall (lower half) or a thickening of the channel wall (upper half).

In the region of the openings 28 of the channel 24 shown in FIG. 11, a connection section 32 is provided that enables the fastening of an external fluid system (not shown) to the channel 24 to be able to introduce flushing fluid into said channel 24 and/or to be able to extract flushing fluid from it. A bead (upper half) and a groove (lower half) are shown by way of example. Other fixing means, additionally or alternatively also in the interior of the channel 24, can be provided as required. A type of “insertion funnel” can also be provided in the section 32 that receives a connection element at the fluid system side.

FIGS. 12 to 14 show a base element 17A that is provided with a plurality of openings 34 at its surface to be printed. Furthermore, an opening 34A is provided at the peripheral surface of the base element 17A. As indicated by dashed lines in FIG. 14, the openings 34, 34A communicate with one another through channels 24A. If a cylinder 16 having a hollow space 18 is now printed on the surface of the element 17A, at least one connection between the hollow space 18 and the environment automatically results on a suitable distribution of the openings 34, namely at least via the opening 34A and/or another opening 34. Openings 34 not required for the respective specific case can be closed by suitable elements, e.g. plugs or stoppers. The bore pattern and/or channel pattern can be adapted as desired. The base element 17A offers great flexibility since it can be used in the manufacture of the most varied components. A base element that implements the concept explained by way of example with reference to the base element 17A can be combined with printed channels 24 and/or separate channel components.

A variant of a separate channel component is shown with reference to FIGS. 15 to 17. A separate channel component 24B is of a substantially tubular design in the example shown (see FIG. 16). The ends of the component 24B not in connection with the hollow space 18 of the cylinder 16 each have a recess 36 at their upper side, said recesses 36 enlarging the inlet opening 28. This measure can be advantageous when using comparatively high viscosity fluids. As can be seen in FIG. 17 (view from below), the component 24B extends through the cylinder 16. It thereby gives the cylinder 16 additional stability. However, in order to disturb the outflow of fluid from the hollow space 18 as little as possible, the component 24B is provided with recesses 36A at its upper side and its lower side. In addition, sidewall sections 38 of the component 24B that are located in the interior of cylinder 16 have openings 40. The recesses 36A and the openings 40A facilitate the penetration of fluids into the interior of the component 24B without unduly reducing its stabilizing effect. The component 24B can as already mentioned be a separate component that consists of the same material as the component/model to be manufactured. It can in particular be printed separately. It is, however, also possible to use a different material. In accordance with an alternative embodiment of the invention, the component 24B is printed together with the component/model to be manufactured.

The hollow space 18 can additionally or alternatively comprise (further) stabilizing or supporting elements to ensure that the cylinder 16 maintains its shape beyond the manufacturing process. Such elements can, for example, be ribs or webs that are arranged at the inner wall of the hollow space 18 and/or extend through it. Optionally, guide elements can also be provided that guide the fluids in the interior of the hollow space 18 such that the latter can be efficiently flushed and/or dried. The guide elements can simultaneously also have a stabilizing or supporting effect. The same analogously applies to the stabilizing and supporting elements.

The concept of the invention has been described above by way of example with reference to the hollow space 18 in the interior of a hollow cylinder 16. However, it is understood that this concept can generally be applied to hollow spaces or components/models of any desired shape. A hollow space in the sense of the present disclosure does not necessarily have to be a closed space. It can also be partly open and/or can be formed by an undercut.

FIGS. 18 to 20 show a system 42 in accordance with the invention that comprises a flushing apparatus 43 having a flushing chamber 43A. The model 10 still arranged on the base element 17, 17A or not is introduced into the chamber 43A.

This system is preferably combined with an apparatus for printing a component in a liquid bath.

FIG. 18 schematically shows that the openings 28 of the channels 24 (not shown) are connected to fluid system connections 44A, 44B of a fluid system in a first step to be able to flush the hollow space 18 of the model 10. This step can take place manually, semi-automatically, or automatically. This also applies to the steps described in the following. A control device is in particular provided that controls the system and suggests suitable control programs to the operator or even (partly) creates them, e.g. on the basis of external data, input data, or data determined by means of sensors. These data can, for example, be based on the digital model of the component to be produced.

The base element 17, 17A is preferably mechanically coded and/or marked to be able to always fix it in a fixedly defined position in the chamber 43A. This facilitates the automation of the process.

Flushing fluid (in particular saturated alcohol vapor) is introduced from a flushing fluid reservoir 46A into the hollow space 18 through the connection 44A. The connection 44B serves to remove the flushing fluid that is guided into a flushing fluid reservoir 468. The flushing medium can then be disposed of or recycled. Flushing or cleaning devices can additionally be provided by which the exterior of the model 10 can be flushed or cleaned. Corresponding flushing medium nozzles are in particular provided, but are not shown.

The flushing fluid can be any desired suitable liquid and/or any desired suitable gas/gas mixture.

The fluid system can also be used for drying by guiding a dry and, if necessary, heated gas/gas mixture through the hollow space 18. The flushing process and/or the drying process can each comprise a plurality of flushing or drying steps.

In the present embodiment, the flushing apparatus 43 also has a hardening apparatus 48 (for example, UV radiators) by which the model can be hardened after the flushing and/or drying. The flushing apparatus 43 thus combines the functionality of a flushing apparatus, a drying apparatus, and a hardening apparatus. It is generally also possible to implement these functionalities with separate units.

### REFERENCE NUMERAL LIST

10 model
12 dental prosthesis component
14 web
16 hollow cylinder
17, 17A base element
18 hollow space
20 embedding medium
22 housing cylinder
24, 24A, 24B channel
26 bend
28 opening
30 constriction
32 connection section
34, 34A opening
36 recess
38 side wall section
40 opening
42 system
43 flushing apparatus
43A flushing chamber
44A, 44B fluid system connection
46A, 46B flushing medium reservoir
48 hardening apparatus

1. A method of manufacturing a component by means of a three-dimensional printing process, said method comprising the steps:
providing a base element; and
printing the component in a liquid bath on the base element such that the component has a hollow space after a completion of the printing,
wherein at least one channel is provided that establishes a fluid connection between the hollow space and the environment at least after the completion of the printing.

2. The method in accordance with claim 1,
wherein the channel is at least sectionally bounded by the base element.

3. The method in accordance with claim 1,
wherein
the channel is at least sectionally integrated into the base element.

4. The method in accordance with claim 1,
wherein
the channel is at least partly produced on the printing of the component.

5. The method in accordance with claim 1,
wherein
the hollow space is at least sectionally bounded by the base element after the completion of the printing.

6. The method in accordance with claim 1,
wherein
the channel has at least one wound section, one curved section, and/or one section extending obliquely to a longitudinal axis of the channel.

7. The method in accordance claim 1,
wherein
a cross-section of the channel varies locally.

8. The method in accordance claim 1,
wherein
an end of the channel remote from the hollow space has an interface for connecting the channel to a separate fluid system.

9. The method in accordance with claim 1,
wherein
at least one support structure for increasing the stability of the component and/or at least one guidance structure for selectively guiding fluid is/are provided in the interior of the hollow space.

10. The method in accordance claim 1,
wherein
at least one of the support structure ands the guidance structure is in connection with the channel.

11. The method in accordance claim 1,
wherein
at least two channels are provided that are in fluid communication with the hollow space, with the channels being distributed in a peripheral direction of the component, and/or with the channels being arranged in one plane or in different planes, viewed in a printing direction of the component.

12. The method in accordance with claim 1,
wherein
the printing process is a stereolithography process, a CLIP process (continuous liquid interface production), and/or a hybrid process.

13. The method in accordance with claim 1,
liquid of the liquid bath present in the hollow space is removed through the channel after the printing.

14. The method in accordance with claim 1,
wherein
at least one of a flushing liquid and a flushing gas is introduced into the hollow space through the channel after the printing.

15. The method in accordance with claim 1,
wherein
the component is dried after the flushing.

16. The method in accordance with claim 1,
wherein
the component is hardened after a removal of the liquid from the hollow space and/or after the flushing of the hollow space.

17. The method in accordance with claim 1,
wherein at least one of
the channel and the base element is separated from the component after the printing, after the flushing, after the drying, or after the hardening of the component.

18. A system comprising a printing apparatus for printing a component in a liquid bath in accordance with a method of manufacturing a component by means of a three-dimensional printing process, said method comprising the steps:
providing a base element; and
printing the component in a liquid bath on the base element such that the component has a hollow space after a completion of the printing,
wherein at least one channel is provided that establishes a fluid connection between the hollow space and the environment at least after the completion of the printing.

19. A system comprising a flushing apparatus for flushing a component manufactured using a method of manufacturing a component by means of a three-dimensional printing process, said method comprising the steps:
providing a base element; and
printing the component in a liquid bath on the base element such that the component has a hollow space after a completion of the printing,
wherein at least one channel is provided that establishes a fluid connection between the hollow space and the environment at least after the completion of the printing,
wherein the flushing apparatus has a flushing device which can be coupled to the channel of the component and by which at least one of a flushing liquid and a flushing gas can be introduced into the hollow space.

20. The system in accordance with claim 19,
wherein
the flushing apparatus comprises a flushing chamber in which the component can be arranged, with the flushing chamber having at least one flushing element for applying at least one of a flushing liquid and a flushing gas to the component.

21. The system in accordance with claim 19,
further comprising
a drying apparatus for drying the component.

22. The system in accordance with claim 19,
further comprising
a hardening apparatus for hardening the component.

23. The system in accordance with claim 19,
further comprising
a fixing apparatus for a positionally accurate fixing of the base element in the printing apparatus, in the flushing apparatus, in the drying apparatus, and/or in the hardening apparatus.
